(19) United States
(12) Patent Application Publication
(10) Pub. No.: US 2017/0253817 A1
(43) Pub. Date: Sep. 7, 2017

(54) Method and device for the production of synthesis gas for operating an internal combustion engine

(71) Applicant: KOPF SynGas GmbH & Co. KG, Sulz-Bergfelden (DE)

(72) Inventor: Johannes Judex, Tuebingen (DE)

(21) Appl. No.: 15/438,948

(22) Filed: Feb. 22, 2017

(30) Foreign Application Priority Data
Mar. 4, 2016 (DE) 102016103924.1

(51) Int. Cl. C10J 3/66; F02B 43/08; C10J 3/48; C10J 3/82; C01B 3/02; C10J 3/46

(52) U.S. Cl. CPC C10J 3/66; C01B 3/02; C10J 3/466; C10J 3/485; C10J 3/82; F02B 43/08; C10J 2300/094; C10J 2300/1643

(57) ABSTRACT

A method for producing synthesis gas for operating an internal combustion engine from an organic solid fuel decomposed into pyrolysis products in a pyrolysis reactor without an oxygen supply, includes feeding the pyrolysis products from a bottom of the pyrolysis reactor to a fluidized bed reactor. A synthesis gas produced in the fluidized bed reactor is withdrawn as product gas. The products gas is directly or indirectly fed to the internal combustion engine. The pyrolysis reactor is operated using at least one pyrolysis auger for conveying the solid fuel. The fluidized bed reactor is fluidized by supplying air at a rate above a minimal loosening rate of the bed material of the fluidized bed of the fluidized bed reactor.

### CROSS-REFERENCE TO A RELATED APPLICATION

The invention described and claimed hereinbelow also is described in German Patent Application 10 2016 103 924.1, filed on Mar. 4, 2016. The subject matter of the German Patent Application is incorporated herein by reference and, provides the basis for a claim of priority of invention under 35 U.S.C. 119(a)-(d).

### BACKGROUND OF THE INVENTION

The present invention relates to a method and a device for producing synthesis gas for operating an internal combustion engine from an organic solid fuel that is decomposed into pyrolysis products in a pyrolysis reactor without oxygen supply, which are subsequently fed from the pyrolysis reactor to a further reactor to realize a synthesis gas, which is withdrawn from the further reactor as product gas and fed directly or indirectly to the internal combustion engine, such as is known from DE 10 2010 012 487 A1.

It is known to gasify solid fuels for energy conversion. With respect to the operation of a corresponding gasification plant, various properties of the solid fuels that are used, for example, in the case of organic solid fuels, have proven to be critical. This relates, for example, to the formation of tar or to the purification of the products produced from tar, the ash fusibility of the fuels that are used, the formation and the behavior of ash in the gasification process, impurities such as H₂S, COS, NH₃ and HCN, and the production of dust in conjunction with tar.

While it is only necessary to pay attention to emission limit values when it comes to a thermal utilization of solid fuels, the requirements for a use of the generated synthesis gas in a gas turbine, for example, for power generation, are substantially higher.

For example, in the case of a motor-related use, high tar contents in the generated synthesis gas can result in damage to downstream gas engines.

Although a utilization of biogenic waste materials, such as sewage sludge, is very highly desirable simply for reasons of environmental protection and sustainability, challenges specifically with respect to a utilization via gasification result in this case.

Sewage sludge usually has a high ash content and a low ash melting temperature. Thus, it is usually not possible, for example, due to the ash melting point, to provide a secondary handling of tar in the case of solid fuels such as sewage sludge using high temperatures in the gasification plant to avoid an unwanted formation of slag during the gasification.

In the method known from WO 2011/110 138 A1, and in the case of the associated device for producing synthesis gas, vegetable oils or diesel are used for the secondary purification of the synthesis gas of tar. Described therein is a device for producing synthesis gas for operating an internal combustion engine from an organic solid fuel which is decomposed into pyrolysis oil, pyrolysis coke and pyrolysis gas in a pyrolysis reactor without oxygen supply, wherein the pyrolysis oil and the pyrolysis coke are subsequently fed to a fluidized bed reactor and are fluidized by supplying air at a rate above the minimal loosening rate of the bed material of the fluidized bed of the fluidized bed reactor, and wherein a synthesis gas produced in the fluidized bed reactor is withdrawn from the fluidized bed reactor as product gas and is fed directly or indirectly to the internal combustion engine. The pyrolysis gas is washed with RME, for example, before use. This occasionally results in a saponification of the washing agent, however, as soon as alkali-rich fuels are used.

In the prior art, attempts also have been made to avoid the formation of tar altogether, rather than to subsequently remove the tar. For this purpose, it is proposed in DE 10 2007 012 452 A1 and in DE 10 2010 018 197 A1, to implement pyrolysis or thermolysis upstream from the actual gasification process, as pre-gasification. The processes described therein are suitable however, for fuels having a low ash content and a low ash density, since dust emerges from the reactor as fly ash.

WO 02/04 574 A1 describes a method which uses counterflow fixed-bed pyrolysis. Tars contained in the pyrolysis gas are conveyed to the cracking process through a hot coke bed. In a further step, the coke is burned in a fluidized layer and a portion of hot ash is added to the coke bed. A water vapor generator is required, however, whereby the entire process becomes more complex and costly. In addition, necessary reactions of water vapor with tar take place substantially more slowly than with air and, in some cases, do not even proceed to completion.

WO 2010/015 593 A2 describes a process in which volatile elements are extracted from a fuel in a first allothermal gasification with water vapor, in a fluidized bed with the aid of burners, and coke from the first process is autothermically gasified in a downstream process. Both gas flows from the processes are combined and jointly undergo further processing. Although the process is easier to carry out in this case, a steam boiler is necessary and so is additional burner energy to sustain the first allothermal process. In addition, no primary tar reduction is provided, as long as gas from the first process cannot react again with air and/or does not come into intensive contact with a coke bed.

In addition, a two-stage process is proposed in the document WO 2011/110 138 A1. Fuel is pyrolyzed in a rotating cylinder and is then separated into coke and gas, and the coke is gasified in a fluidized bed. This process is technically difficult to handle since a gas-solid separation on the hot side is required. The synthesis gas obtained from the coke in this method is supposed to be subsequently mixed again with the pyrolysis gas. The disadvantage thereof is that the pressure conditions must be very exactly controlled. Further problems result from the use of a drum or a rotating cylinder, since these cannot withstand high pressures, as experience has shown. It is also disadvantageous that induced draught ventilators used in this method only have a short life expectancy. Furthermore, underpressure in the device results in an introduction of air, whereby uncontrolled Ex zones can result.

As mentioned, DE 10 2010 012 487 A1 describes a method and a device for producing synthesis gas for operating an internal combustion engine from an organic solid fuel which is decomposed into pyrolysis products in a pyrolysis reactor without oxygen supply, wherein all the pyrolysis products are subsequently fed from the bottom of the pyrolysis reactor to a further reactor, which is designed as a fixed-bed reactor, wherein a synthesis gas produced in the further reactor is withdrawn from the further reactor as product gas and is fed directly or indirectly to the internal combustion engine, and wherein the pyrolysis reactor is operated using at least one pyrolysis auger for conveying the solid fuel. The fixed-bed reactor comprises a stirring device which, on the one hand, is used for thoroughly mixing the solid-material layer located in the high-temperature zone, to achieve a conversion which is as complete as possible.

Contrasted therewith is a fluidized bed reactor, for example, in WO 2011/110 138 A1, which was discussed above, or in WO 02/004 574 A1. The characteristic of a fluidized bed is that of an “ideal mixing vat”. An extent of intermixture as described in DE 10 2010 012 487 A1, would be more of a hindrance than a help for this purpose. The characteristic also results in the fact that no significantly different temperature zones (e.g., high-temperature zone) is operated within a fluidized bed.

The word “fluidized bed” is used in DE 10 2010 012 487 A1, for a low dust load which is blown into the reactor with the gasification air and, in this way, is supposed to circulate. Since this is a secondary process, however, and the main portion of the masses, as described above, are present as a fixed bed, the further reactor according to DE 10 2010 012 487 A1, is not a fluidized bed reactor, but rather a fixed-bed reactor.

### SUMMARY OF THE INVENTION

The present invention overcomes shortcomings of known arts, such as those mentioned above.

The present invention provides a device and a method, in which (or by way of which) solid fuels, organic solid fuels, such as, for example, biogenic waste material, sewage sludge, paper pulp, pomace, husks, manure, shells or the like, is gasified, particularly cost-effectively in a stable process, into a synthesis gas, and therefore the synthesis gas is suitable for being used in a motor-related manner, for example, by a gas turbine.

The invention relies upon a further reactor designed as a fluidized bed reactor that is fluidized by supplying air at a rate above the minimal loosening rate of the bed material of the fluidized bed of the fluidized bed reactor, a biogenic waste material having an ash content of at least 20% of the solid mass of the solid fuel is fed to the pyrolysis reactor as the organic solid fuel, and the organic solid fuel is decomposed into pyrolysis oil, pyrolysis coke, and pyrolysis gas in the pyrolysis reactor.

A device for carrying out the method, is distinguished by the cross-sectional area of the clear inner space of the fluidized bed reactor increasing from the bottom toward the top, in particular at least in sections in the manner of an inverted cone.

The invention includes a method for producing synthesis gas from an organic solid fuel, which makes it possible to convey a biogenic waste material having a high ash content using a pyrolysis auger, and to simultaneously pyrolyze and thermolyze the material, wherein all the products of pyrolysis oil, pyrolysis coke and pyrolysis gas, are subsequently fed to the fluidized bed reactor. It is therefore possible to gasify the biogenic waste material as comprehensively as possible and to treat resultant tars in the process itself. It is advantageous in this case that it is not only the pyrolysis coke, but also all products of the pyrolysis and thermolysis that are fed to the fluidized bed reactor. In this way, the situation is avoided in which various flows must be coordinated in parallel.

In addition, the pyrolysis gas is fed to the fluidized bed reactor from the bottom. Thus, the pyrolysis gas in the fluidized bed reactor also is exposed to an oxygen-rich zone, in which tar is decomposed and burned. In this case, use is also made, particularly advantageously, of the fact that the pyrolysis coke catalytically supports the decomposition of tar contained in the pyrolysis gas. This is also possible since pyrolysis coke has a larger specific surface than the original solid fuels that were used.

This method, therefore, provides for a primary tar treatment for otherwise poorly gasifiable biogenic waste materials. A homogeneous, low-tar synthesis gas results.

The method also is suited, advantageously and specifically, for solid fuels having high ash melting temperatures and ash densities as well as high ash contents, since it is not necessary that resultant dust emerge from the reactor as fly ash. Thus, the inventive method is used with the most highly diverse biogenic waste materials such as, for example, sewage sludge, pomace, manure or shells.

Biogenic waste materials having high ash contents of at least 20% of the solid mass of the solid fuel, can therefore be gasified in a low-tar manner.

In a method embodiment, the biogenic waste materials fed to the pyrolysis reactor as organic solid fuel has solid contents between 80% and 98% and includes sewage sludge and/or paper pulp and/or pumace.

The fluidized bed reactor is operated in a stationary or circulating manner.

The pyrolysis reactor also can comprise multiple pyrolysis augers. The pyrolysis reactor also can comprise a twin auger or multiple-auger. In other words, several augers are used for a fluidized bed reactor.

It is preferred when the biogenic waste material fed to the pyrolysis reactor as organic solid fuel has solid contents between 80% and 98% and includes sewage sludge and/or paper pulp and/or pomace. The inventive is particularly advantageously suited for processing such organic solid fuels which, until now, have been only unsatisfactorily gasifiable.

An advantage of the invention results from the fact that the fluidized bed reactor is operated at an operating temperature 5-960° C. Thus, the formation of slag in the case of solid fuels having a low ash melting temperature, is counteracted.

If the pyrolysis auger is heated externally, a dilution of the fuel with a heating medium is avoided. Likewise, a premature addition of oxygen, which would greatly reduce the calorific value, also is avoided, thus.

In an embodiment, the heating of the pyrolysis auger takes place using heated gas, preferably heated air. Thus, the pyrolysis reactor is not loaded with dusty synthesis gas, whereby a premature wear of gas ducts of the pyrolysis reactor is avoided. Advantageously, hot product gas from the fluidized bed reactor is used for heating the gas.

In addition, a thermolysis burner is used for further increasing the temperature of the gas.

In one embodiment, air is fed into the fluidized bed reactor from the bottom or from the side using an air flow that is just sufficiently great enough for sustaining the vortexing and cracking process in the fluidized bed reactor, and in which the air is supplied at a rate which is only between 5% and 20%, preferably approximately 10%, above the minimum loosening rate required for operating the fluidized bed reactor. Thus, a fluidized bed forming in the fluidized bed reactor is advanced to very close to its loosening point. Thus, the contact between the pyrolysis gas and the fluidized bed material is further optimized. The catalytic cracking of tar on the pyrolysis coke, in addition to the gas-phase reaction with oxygen, is thereby intensified. For this purpose, the fluidized bed reactor is operated in a stationary manner.

In a method embodiment, calcium-containing material, such as calcium carbonate, calcite or calcium hydroxide, is added already in the fluidized bed reactor for a primary sulfur absorption. For this purpose, the calcium-containing material is admixed to the original solid fuel, for example. Thus, large portions of volatile sulfur are bound as calcium sulfide and removed from the process via the ash at an early point in time.

In one embodiment, the ash, which is either already present in the form of granulate or is further processed to form granulate, is recycled as bed material for the fluidized bed.

The scope of the invention also covers a device for carrying out the method according to the invention, which is distinguished by the cross-sectional area of the clear inner space of the fluidized bed reactor increasing from the bottom toward the top, in particular, at least in sections in the manner of an inverted cone. For this purpose, at least portions of the lower region of the fluidized bed reactor are eccentrically shaped. Since the gas quantity increases from the bottom toward the top, the flow velocity in the fluidized bed reactor can therefore be advantageously held approximately constant along the fluidized bed reactor.

The scope of the invention also covers a device for carrying out the inventive method, in which an opening for the gravitational discharge of the ash accumulating during the operation of the fluidized bed reactor is present on the side of the fluidized bed reactor, preferably at the end of the fluidized bed and at the beginning of the gas chamber. In this case, the gas chamber is the region within the fluidized bed reactor, which adjoins the fluidized bed above the fluidized bed. This is advantageous in this case that large quantities of ash also is extracted from the fluidized bed thus. The opening can function as an overflow, and therefore the fluidized bed behaves in the manner of an overflowing vat, whereby the ash discharge is automatically regulated.

In addition, a device is provided for conveying initially cold air out of the fluidized bed reactor in counterflow to the discharged ash. Losses on ignition of less than 1% usually do not occur in a fluidized bed. Due to the additional injection of air into the ash discharge, ash is freed from the remaining carbon and the resultant exhaust gas is introduced into the fluidized bed. In addition, heat is recovered from the ash thus, and therefore the energy efficiency of the device is improved. In this case, it is particularly advantageous when the initially cold air is withdrawn from the path of the air fed to the fluidized bed reactor for the gasification. Thus, it is ensured that a sufficient flow is always present even under fluctuating pressure conditions in the plant.

In an alternative refinement, it is provided that a further device for feeding air into the fluidized bed reactor is present on the side, in the region between the fuel inlet and the ash discharge of the fluidized bed reactor, which air is preferably withdrawn as a bypass air flow from the air supply into the fluidized bed reactor, which takes place from the bottom for fluidization. It is preferred when an additional device for feeding air into the fluidized bed reactor is present on the side, in the region above the ash discharge in the gas chamber of the fluidized bed reactor, which air is preferably withdrawn as a bypass air flow from the air supply into the fluidized bed reactor. These additional air supplies are uniformly distributed around the circumference of the fluidized bed reactor. As a result of such additional air supplies, additional control possibilities result for controlling the process sequences within the fluidized bed reactor. These additional air supplies allow for a further improved, controlled combustion of tar by means of the stepped addition of air and oxygen.

In an embodiment, a device for cooling product gas removed from the fluidized bed reactor, comprising a Venturi scrubber, and/or a device for aerosol deposition, comprising a centrifugal scrubber and/or a device for ammonia deposition, comprising a spray scrubber, is provided after a first cooling stage and a dust-removing device. Preferably, all three of the devices provided are connected in series. Refinements also are preferred in which one or multiple devices are provided for removing mercury and/or hydrogen sulphide and/or hydrocarbons from the product gas withdrawn from the fluidized bed reactor. These preferably operate based on adsorption or filtering, based on activated-carbon filtering. Thus, the quality of the synthesis gas that is produced is further improved. Since sewage sludge ash has a high porosity and/or a high specific surface, it is possible, in an embodiment, to use accumulating sewage sludge ash rather than activated carbon, for filtering H₂S.

It is understood that the features mentioned above and which are described in the following may be used not only in the combination described, but also in other combinations or alone, without departing from the scope of the present disclosure.

### BRIEF DESCRIPTION OF THE DRAWINGS

The invention is schematically depicted in the drawing and is described in greater detail regarding one exemplary embodiment.

FIG. 1 presents a schematic depiction of one embodiment of the device for carrying out the method according to the invention.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

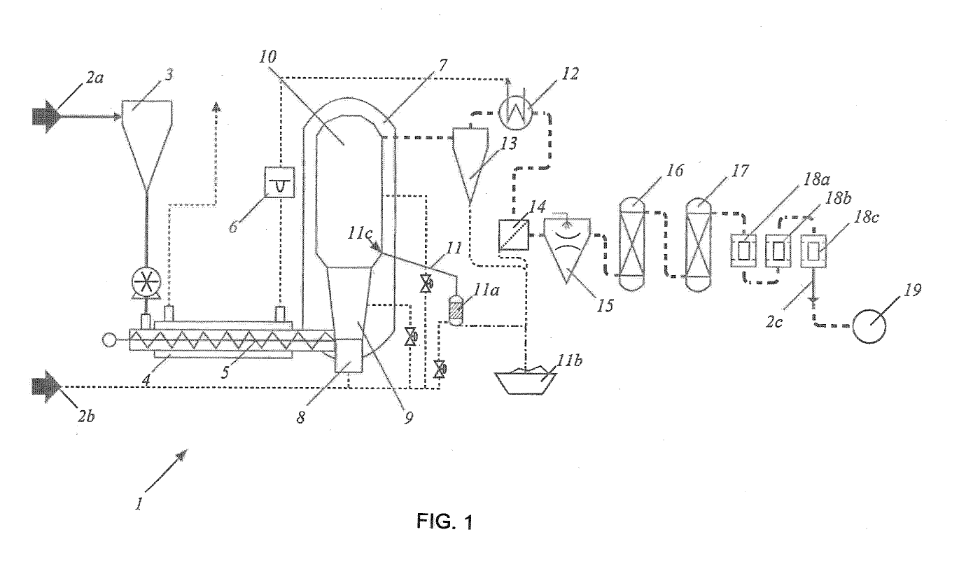

FIG. 1 depicts a gasification device 1. This gasification device is used for implementing the method for producing synthesis gas for operating an internal combustion engine from an organic solid fuel, according to the invention. Fuel is fed to a fuel silo 3 by a fuel supply 2a. In this exemplary embodiment, sewage sludge in the form of sewage sludge pellets having 90% solid content is used as the fuel. A predefined quantity of calcium carbonate is added to the fuel in the fuel silo 3. Calcium carbonate is added in this case to subsequently primarily reduce sulfur in the gas phase.

The fuel, which has been preconfigured in this way, is subsequently introduced into a pyrolysis reactor 4. The pyrolysis reactor 4 comprises a pyrolysis auger 5, which is a twin auger in this case. The pyrolysis reactor 4 is held at a constant temperature by the infeed of heating gas. For this purpose, air is preheated in an air preheater 12 and is additionally heated up, as necessary, by a thermolysis burner 6, which is operated using sewage gas in this exemplary embodiment. The heating takes place in this case externally by the heating gas. Thus, an admixture of heating gas with pyrolysis educts and products is avoided. The pre-stage is preferably operated in a temperature window between 600-650° C. In the present embodiment, the pyrolysis process is carried out in an oxygen-free manner, and therefore this corresponds to a thermolysis. Pyrolysis gas, pyrolysis coke, and pyrolysis oil are formed as process products during the pyrolysis or thermolysis.

In one further method step, the process products from the pyrolysis reactor 4 are transferred to a fluidized bed reactor 7. A feed auger, which is not depicted in FIG. 1 greater detail, is provided in this exemplary embodiment. The pyrolysis products are introduced into the fluidized bed reactor 7 from the bottom by feed auger. A wind box 8 is disposed on the underside of the fluidized bed reactor 7. By this wind box 8, gasification air is fed from a gasification-air supply 2b to the fluidized bed reactor 7. The fluidized bed reactor 7 extends eccentrically and to expand conically upward in the region of a fluidized bed 9 that is forming. A gas chamber 10 adjoins the fluidized bed 9. In the sense of two bypasses, a portion of the gasification air is branched off from the branch leading to the wind box 8 and is fed, in part, in the region of the fluidized bed 9 and, in another part, in the region of the gas chamber 10.

Slightly above the fluidized bed 9 there is an ash discharge duct 11 which leads into an opening 11c located in a wall of the fluidized bed reactor 7. The ash discharge duct 11 has a slant, and therefore ash is gravitationally discharged out of the inner chamber of the fluidized bed reactor 7 via the ash discharge duct 11. From there, the ash passes through a cooling reactor 11a and enters an ash trap 11b. Ash is removed therefrom, as necessary, also as a substitute for activated carbon, and is used in filter devices 18a, 18b and 18c which are described in greater detail further below.

A portion of the gasification air withdrawn from the gasification-air supply 2b is conveyed into the fluidized bed reactor 7 in counterflow through the ash discharge duct 11. Thus, a recalcination of the ash takes place and heat is transferred from the hot ash to the initially cold gasification air.

The supply of gasification air is adjusted in such a way that the air supply is just sufficiently great enough for sustaining vortexing and cracking processes in the fluidized bed reactor 7. The air is supplied at a rate of approximately 10% above the minimum loosening rate required for operating the fluidized bed reactor 7. It is thereby ensured that the pyrolysis gas has good contact with the bed material of the fluidized bed. Furthermore, a catalytic cracking of the tar on the pyrolysis coke obtained in the process products of the pyrolysis reactor 4 takes place already in the fluidized bed 9.

As soon as the material flow forming in the fluidized bed reactor 7 reaches the opening 11c of the ash discharge duct 11, ash is gravitationally discharged from the material flow.

The operating temperature of the fluidized bed reactor 7 is regulated to ≦960° C. In alternative embodiments, the method provides aligning the operating temperature with the particular ash melting temperature of the solid fuel that is used. As soon as the material flow has reached the upper end of the fluidized bed reactor 7 or the gas chamber 10, the material flow emerges from the fluidized bed reactor 7 in the form of hot synthesis gas.

In subsequent steps, this synthesis gas is dedusted and purified, and the heat contained therein is recovered. For this purpose, the synthesis gas is initially conveyed to a dust-removing device 13. In this exemplary embodiment, the dust-removing device 13 is a cyclone separator for removing the predominant portion of fly ash still present therein. Next, the synthesis gas, which is still at approximately 800° C. in this phase, is conveyed over the heating gas preheater 12, which is used for preheating the heating gas of the pyrolysis reactor 4, as described above. The synthesis gas reemerges from the heating gas preheater 12 at a temperature of approximately 400° C. and is passed through a tubular filter 14 to a Venturi scrubber 15, by which the synthesis gas is further cooled and purified. Aerosols that have formed are subsequently separated out in a device for aerosol deposition 16, which is a centrifugal scrubber in this case. The synthesis gas is then routed to a device for ammonia deposition 17. In this case, the device for ammonia deposition 17 is designed as a spray scrubber.

In a final step, the synthesis gas, which has now already been precleaned, is freed of remaining impurities and pollutants. For this purpose, after emerging from the device for ammonia deposition 17, the synthesis gas is conveyed over a recuperator which is not depicted in greater detail in FIG. 1. The recuperator is used for preventing the formation of mist and, in general, for ensuring that the dew point is not reached. A portion of the heating-gas exhaust gas from the pyrolysis reactor 4 is used for heating the synthesis gas in recuperator.

The synthesis gas then sequentially reaches three filter devices 18a, 18b, 18c. In this exemplary embodiment, these filter devices 18a, 18b, 18c are activated-carbon filters and activated-carbon absorbers. A predefined portion of the activated carbon is replaced by sewage sludge ash, from the ash trap 11b, having been aligned with the dimension of the filter devices 18a, 18b, 18c and the required filter yields. Advantage is taken of the fact, in this case, that the sewage sludge ash is like activated carbon in that it has a high porosity and specific surface. In other words, the sewage sludge ash is at least partially reused as filter material.

The filter device 18a is used in this case for separating out any mercury remaining in the synthesis gas. The filter device 18b is used for separating out the hydrogen sulphide remaining in the synthesis gas. The final filter device 18c is used for separating out any hydrocarbon-containing pollutants that remain. The filter device 18c is therefore a policing filter.

The synthesis gas, which has been produced, dedusted and purified in this way, now has a quality which enables the requirements on a motor-related use to be met. Thus, the synthesis gas that is available at the filter device 18c or at a synthesis-gas outlet 2c adjoining said device can now be transferred, for example, to an internal combustion engine 19 for an energy-related use. For this purpose, the internal combustion engine 19 is designed as a gasoline engine having an attached generator and an attached device for utilizing waste heat in the sense of an energy-based co-generator. Thus, the originally supplied solid fuel, sewage sludge, is utilized comprehensively in an energy-related manner, electrically and thermally. Alternatively, the organic solid fuels may further comprise combinations of biogenic waste material, sewage sludge, paper pulp, pomace, husks, manure, shells or the like, for gasification into the synthesis gas, which is suitable for motor-related use by means of a gas turbine.

### LIST OF REFERENCE NUMBERS

1 gasification device
2a fuel supply
2b gasification-air supply
2c synthesis gas outlet
3 fuel silo
4 pyrolysis reactor
5 pyrolysis auger
6 thermolysis burner
7 fluidized bed reactor
8 wind box
9 fluidized bed
10 gas chamber
11 ash discharge duct
11a cooling reactor
11b ash trap
11c opening
12 heating-gas preheater
13 dust-removing device
14 tubular filter
15 Venturi scrubber
16 device for aerosol deposition
17 device for ammonia deposition
18a-c filter devices
19 internal combustion engine

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method for producing synthesis gas, for operating an internal combustion engine, from an organic solid fuel, the method comprising the steps of:
conveying organic solid fuel to a pyrolysis reactor using a pyrolysis auger;
decomposing the organic solid fuel into pyrolysis products in the pyrolysis reactor, without an oxygen supply;
feeding the pyrolysis products from a bottom of the pyrolysis reactor to a fluidized bed reactor;
producing a synthesis gas in the fluidized bed reactor; and
withdrawing the synthesis gas from the fluidized bed reactor as product gas and directly or indirectly feeding the product gas to the internal combustion engine;
wherein fluidized bed reactor is fluidized by supplying air at a rate above a minimal loosening rate of a bed material of a fluidized bed of the fluidized bed reactor;
wherein the organic solid fuel comprises a biogenic waste material having an ash content of at least 20% of a solid mass of the organic solid fuel; and
wherein the pyrolysis products formed in the pyrolysis reactor in the step of decomposing are pyrolysis oil, pyrolysis coke, and pyrolysis gas.

2. The method according to claim 1, wherein the biogenic waste material comprising the organic solid fuel has solid contents between 80% and 98% and includes one or more of the group consisting of: sewage sludge; paper pulp; and pomace.

3. The method according to claim 2, further including operating the fluidized bed reactor at an operating temperature ≦960° C.

4. The method according to claim 1, further including a step of externally heating the pyrolysis auger.

5. The method according to claim 4, wherein the step of externally heating the pyrolysis auger relies upon heated gas such as heated air.

6. The method according to claim 5, wherein the heated gas is the hot product gas from the fluidized bed reactor.

7. The method according to claim 5, wherein the step of externally heating the pyrolysis auger relies upon a thermolysis burner for further increasing the temperature of the heated gas.

8. The method according to claim, wherein the step of feeding includes feeding air into the fluidized bed reactor from the bottom or from an air flow that is characterized as sufficient to sustain a vortexing and cracking process in the fluidized bed reactor, and wherein said air is supplied at an air flow rate that is between 5% and 20% above a minimum loosening rate required for operating the fluidized bed reactor.

9. A device for producing synthesis gas, for operating an internal combustion engine, from an organic solid fuel, comprising:
a pyrolysis auger for conveying organic solid fuel;
a pyrolysis reactor for receiving the organic solid fuel from the pyrolysis auger and decomposing the organic solid fuel into pyrolysis products, without an oxygen supply;
a fluidized bed reactor for receiving the pyrolysis products from a bottom of the pyrolysis reactor and producing a synthesis gas, therefrom;
means for withdrawing the synthesis gas from the fluidized bed reactor as product gas, and directly or indirectly feeding the product gas to an internal combustion engine;
wherein fluidized bed reactor is fluidized by supplying air at a rate above a minimal loosening rate of a bed material of a fluidized bed of the fluidized bed reactor;
wherein the organic solid fuel comprises a biogenic waste material having an ash content of at least 20% of a solid mass of the organic solid fuel;
wherein the pyrolysis products formed in the pyrolysis reactor are pyrolysis oil, pyrolysis coke, and pyrolysis gas; and
wherein a cross-sectional area of a clear inner space of the fluidized bed reactor increases from a bottom toward a top of the fluidized bed reactor, at least in sections in a manner of an inverted cone.

10. The device for producing synthesis gas according to claim 9, wherein an opening is included in a side of the fluidized bed reactor for the gravitational discharge of ash accumulating during operation of the fluidized bed reactor.

11. The device for producing synthesis gas according to claim 10, wherein the opening at the end of the fluidized bed and at a beginning of a gas chamber, therein.

12. The device for producing synthesis gas according to claim 10, comprising a device for conveying initially cold air out of the fluidized bed reactor in counterflow to the discharged ash.

13. The device for producing synthesis gas according to claim 9, comprising a further device for feeding air into the fluidized bed reactor, on a side of the fluidized bed reactor, in a region between a fuel inlet and an ash discharge of the fluidized bed reactor, wherein the air that is fed is withdrawn as a bypass air flow from the air supply into the fluidized bed reactor, which takes place from the bottom for fluidization.

14. The device for producing synthesis gas according to claim 13, comprising an additional device for feeding air into the fluidized bed reactor, arranged (7) on the side, in the region above the ash discharge in a gas chamber of the fluidized bed reactor, which fed air is withdrawn as a bypass air flow from the air supply into the fluidized bed reactor.

15. The device for producing synthesis gas according to claim 9, comprising a device for cooling product gas removed from the fluidized bed reactor

16. The device for producing synthesis gas according to claim 15, wherein the device for cooling product gas removed from the fluidized bed reactor comprises one or more of the group consisting of: a Venturi scrubber; a device for aerosol deposition comprising a centrifugal scrubber; and a device for ammonia deposition comprising a spray scrubber, are present after a first cooling stage and a dust-removing device.

17. The device for producing synthesis gas according to claim 16, wherein the device for cooling product gas removed from the fluidized bed reactor comprises a Venturi scrubber, a device for aerosol deposition comprising a centrifugal scrubber and a device for ammonia deposition comprising a spray scrubber, arranged after a first cooling stage and a dust-removing device, and are connected in series.

18. The device for producing synthesis gas according to claim 1, comprising a device for removing any of the group consisting of mercury, hydrogen sulphide, and hydrocarbons from the product gas withdrawn from fluidized bed reactor, and wherein the device for removing operates based on adsorption or filtering, activated carbon filtering.
